(19) United States
(12) Patent Application Publication
(10) Pub. No.: US 2026/0363474 A1
(43) Pub. Date: Nov. 19, 2026

(54) MINIMIZED URINAL FLOOR MAT

(71) Applicant: VECTAIR SYSTEMS LIMITED, Basingstoke (GB)

(72) Inventor: Jeffrey Scott Crevier, Dalton, GA (US)

(21) Appl. No.: 19/750,135

(22) Filed: Jul. 22, 2026

Related U.S. Application Data
(63) Continuation-in-part of application No. 29/942,842, filed on May 17, 2024.
(63) Continuation-in-part of application No. 29/994,621, filed on Mar. 21, 2025.
(60) Provisional application No. 63/848,471, filed on Jul. 22, 2025.

(51) Int. Cl. A47G 27/02; B32B 5/02; B32B 25/08; B32B 37/10; B32B 43/00; D04H 1/4291; D04H 11/00; E03D 9/00

(52) U.S. Cl. CPC A47G 27/0206; B32B 5/022; B32B 25/08; B32B 37/10; B32B 43/003; D04H 1/4291; D04H 11/00; E03D 9/007; B32B 2250/02; B32B 2307/758; B32B 2471/04; D10B 2321/021; D10B 2401/00; D10B 2503/04

(57) ABSTRACT

A floor mat for use under urinals includes a fluid capture layer and a moisture barrier layer. The urinal floor mat is minimized in size, and includes a low tack backing so that it remains in position on the floor under a urinal, without having to be in contact with a wall on which the urinal is mounted. The floor mat is minimized in size to cover just the region under the urinal where the vast majority of urine (or other fluid) falls on the floor under the urinal, rather than covering the entire region under the urinal. The minimized urinal mat can be treated with a buffered bacterial culture that is selected to break down urine while minimizing odor relative to more commonly found bacteria is restrooms. The bacteria are provided in a dormant state and become active in the presence of urine.

### CROSS REFERENCE

This application is a continuation in part of U.S. design application no. 29/942,842, filed May 17, 2024; this application is also a continuation in part of U.S. design application no. 29/994,621, filed Mar. 21, 2025; and this application also claims the benefit of provisional application no. 63/848,471, filed Jul. 22, 2025, the entireties of each of which are hereby incorporated by reference.

### FIELD OF THE INVENTION

The present invention relates generally to floor mats for use under urinals, and, more particularly, relates to a floor mat that includes a fluid capture layer that has a bioactive treatment to breaks down and consume components of urine, and which is configured to be placed directly under the forward end of a urinal. Further, the mat is shaped and sized to capture a large majority of errant urine while minimizing the amount of material needed to do so.

### BACKGROUND OF THE INVENTION

A number of solutions have been implemented to address the inevitable accumulation of urine on the floor under urinals used in public restrooms. Whether the urine falling to the floor is the result of splash from the urinal, or the user simply missing the urinal, the result is the same; urine routinely falls on the floor under urinals. Bacteria species commonly found restrooms are known to break down urine into odor-causing by products. This fact necessitates that restrooms are frequently cleaned to prevent excessive odors, as well as to prevent potentially unsafe conditions from there being excessive fluid on the floor. It is also common to place a mat under the urinal in an attempt to capture any urine that falls outside of the urinal. While such mats are effective at preventing fluid from building up on the floor, they do not avoid the problem of odors created be urine collecting in the mat. As a result, personnel still have to frequently remove and replace the mats and either clean the soiled mats or discard them.

There are several problems with conventional urinal floor mats. First, they can accumulate microbes that contribute to the odor produces by urine. Some manufacturers have addressed this by applying anti-microbial treatments to their urinal mats. This can reduce the odor caused by airborne bacteria that can grow on these mats, but the microbes can become resistant to the anti-microbial material. Second, urinal floor mats generally cover a large area under the urinal, including many areas where urine is never splashed or dropped. But the size of the mat is used to ensure alignment under the urinal. As a result, a lot of the material of the urinal floor mat doesn’t contribute to fluid capture. The floor mats could be made smaller to reduce the manufacturing cost of each floor mat if the mats would stay in position under the urinal. It will be recognized by those familiar with the commercial janitorial arts that a urinal floor mat is distinct from other types of floor mats. For example, conventional bathroom floor mats generally include loose yarns and are made to be trod upon, and provide a measure of comfort; they are not designed to collect errant fluid splash out of a urinal, or urine that misses the urinal.

Therefore, a need exists to overcome the problems with the prior art as discussed above.

### SUMMARY OF THE INVENTION

In accordance with some embodiments of the inventive disclosure, there is provided a floor mat for use under a urinal that includes a fluid capture layer and a moisture barrier layer on which the fluid capture layer is disposed. There is also a backing on a bottom of the moisture barrier layer that has a low-tack back surface. At least one of the fluid capture layer or the moisture barrier layer is treated with a bacterial culture. By “treated with a bacterial culture,” it is meant that a product containing selected types of bacteria is intentionally applied to the urinal floor mat for the purpose of breaking down urine into no, or low odor by products, unlike bacteria commonly found in restrooms, and it also means that the presence of bacteria is not an incidental result of exposure to some type of bacteria, like airborne spores, after it is deployed.

In accordance with a further feature, the fluid capture layer is fibrous.

In accordance with a further feature, the floor mat is circular and has a diameter of not more than about sixteen inches.

In accordance with a further feature, the at least one of the fluid capture layer or the moisture barrier layer is made of a polymeric material.

In accordance with a further feature, the at least one of the fluid capture layer or the moisture barrier layer is made of ethylene vinyl acetate.

In accordance with a further feature, there is further included a removable liner layer disposed the backing.

In accordance with a further feature, the bacterial culture contains at least one species of Bacillus.

In accordance with a further feature, the bacterial culture contains a plurality of species of Bacillus.

In accordance with a further feature, the bacterial culture is applied as a diluted broth to the at least one of the fluid capture layer or the moisture barrier layer.

In accordance with some embodiments of the inventive disclosure, there is provided a urinal floor mat that has a body including a fluid capture layer made of a fibrous material, a moisture barrier layer across a bottom of the fluid capture layer, and there is a buffered bacterial culture applied to the body.

In accordance with a further feature, the body is circular and has a diameter of eight to sixteen inches and a height of not more than one half of an inch.

In accordance with a further feature, fluid capture layer is a non-woven felt.

In accordance with a further feature, the felt is made of a polymeric material.

In accordance with a further feature, the polymeric material is ethylene vinyl acetate.

In accordance with a further feature, there is also a pressure sensitive adhesive layer on the bottom of the moisture barrier layer.

In accordance with a further feature, the bacterial culture contains at least one species of Bacillus.

In accordance with a further feature, the bacterial culture contains a plurality of species of Bacillus.

In accordance with a further feature, the buffered bacterial culture is applied as a diluted broth to the body.

In accordance with some embodiments of the inventive disclosure, there is provided a method of using a floor mat for a urinal that includes providing a floor mat that has a fluid capture layer and a moisture barrier layer on which the fluid capture layer is disposed. The bottom of the moisture barrier layer is covered with a pressure sensitive adhesive, and the fluid capture layer includes a buffered bacterial culture. The method further comprises positioning the floor mat on a floor directly under a front end of the urinal.

In accordance with a further feature, providing the floor mat comprises providing the floor mat as a circular body having a diameter of eight to sixteen inches.

Conventional bathroom or bath mats are designed for general wet-area use (showers, tubs, sinks). They are typically rectangular or oversized, lack any urine-specific bioactive treatment, and are not dimensioned or configured for placement solely under the front end of a urinal. Prior-art urinal mats, by contrast, are deliberately sized to extend from the wall (or other vertical fixture) on which the urinal is mounted forward past the front edge of the urinal. That wall-abutting geometry is relied upon to keep the mat in position; the majority of the mat’s surface area therefore lies outside the primary splash/drip zone and serves no fluid-capture function. The present invention deliberately omits that excess material and the wall-contact requirement.

Although the invention is illustrated and described herein as embodied in a floor mat having a capture layer and a bioactive treatment that allows for the breakdown of urine and the consumption of the enzymatic action by bacteria, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as "up", "down", "left", "right", "inside", "outside", "front", "back", "head", "tail" and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as "first", "second", "third" and so on are only used for descriptive purposes, and cannot be construed as indicating or implying relative importance.

In the description of the embodiments of the present invention, it should be noted that, unless otherwise clearly defined and limited, terms such as "installed", "coupled", "connected" should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the article being referenced. Those skilled in the art can understand the specific meanings of the above-mentioned terms in the embodiments of the present invention according to the specific circumstances.

Conjunctive language such as the phrase "at least one of X, Y, and Z," unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is side view of urinal floor mat having a bioactive treatment for use under a urinal, in accordance with some embodiments of the invention.

FIG. 2 is a top view of the floor mat of FIG. 1.

FIG. 3 is a top view of the floor mat positioned under a urinal, in accordance with some embodiments.

FIG. 4 is a side view of a urinal and floor mat positioned under the urinal, in accordance with some embodiments.

FIG. 5 is a top plan view of a floor mat having a fibrous fluid capture layer that has a bioactive treatment, in accordance with some embodiments.

FIG. 6 is a side elevational view of a floor mat having a fibrous fluid capture layer that is bioactive treatment, in accordance with some embodiments.

FIG. 7 is a bottom plan view of a floor mat having a fibrous fluid capture layer that is bioactive treatment, in accordance with some embodiments.

FIG. 8 is a flow chart diagram of a method of making a bioactive treated urinal floor mat, in accordance with some embodiments.

FIG. 9 is a flow chart diagram of a method of using a bioactive treated urinal floor mat, in accordance with some embodiments.

FIG. 10 shows a manufacturing system schematic of a manufacturing system for manufacturing minimized urinal floor mats, in accordance with some embodiments.

FIG. 11 show an overhead view of the cutting of laminate sheet into individual urinal floor mats, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient floor mat for use under urinals in public restrooms, and elsewhere that urine may fall on the floor. Embodiments of the invention provide a floor mat that has a bioactive treatment to breakdown urine using live microbes (bacteria). This is contrary to conventional approaches to urine capture using urinal mats which have an anti-microbial treatment to prevent bacteria on the floor mat. The use of selected types of live microbes that target urine components reduces the amount of odor resulting from the floor mat, and the effectiveness of the odor control will increase over time, for a period of time. In addition, embodiments of the invention provide a floor mat that can be circular in shape and has a diameter of up to about sixteen inches. The floor mat can also be hexagonal in shape to maximize the manufacturing yield from a sheet of urinal mat stock when singulating out individual urinal floor mats from the urinal mat sheet stock. This physical configuration provides space for a user of a urinal to stand with their feet spaced comfortably apart, without stepping on the floor mat. The size also makes it very easy to remove and replace the floor mat as it is the size of a typical dinner plate or smaller.

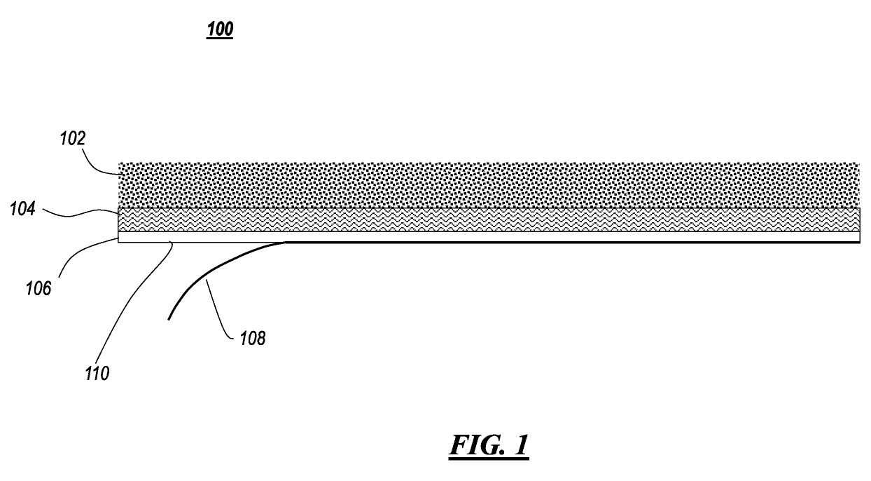

FIG. 1 is side view of floor mat 100 having a bioactive treatment for use under a urinal, in accordance with some embodiments of the invention. The floor mat includes a fluid capture layer 102 that can be, for example, a non-woven fibrous layer that provides a mat of strands of material that provide an absorptiveness to prevent splash. Thus, the fluid capture layer 102 is configured to receive drops or droplets of fluid, or even brief streams of fluid, and reduce, if not prevent splashing out of the fluid capture layer 102. The fluid capture layer 102 in general can be a non-woven, felt-like material. In some embodiments the fluid capture layer can be made of an EVA (ethylene vinyl acetate) polymeric material and supported on a moisture barrier layer 104 that can also be EVA, or rubber, but which does not have openings and forms a fluid barrier. A moisture barrier layer 104 holds the material of the fluid capture layer 102 in place. There can be a backing layer 106 on the bottom of the moisture barrier layer 10 that provides a low tack surface 110 to help hold the mat 100 in place on the floor when placed on the floor. A removable liner layer 108 can be placed over the backing layer 106 to protect the low tack surface 110 from getting dirty before placing the mat in its intended use location.

A bioactive treatment is applied to the floor mat by dispersing a bioactive material into the fluid capture layer 102 and/or onto the moisture barrier layer 104. The bioactive material includes one or more cultivars of buffered bacterial culture that are known to break down components of urine through enzymatic action, but which also are selected for producing less odorous by-products relative bacteria species that commonly occur in restrooms, and which are associated with odors as a result of their action on urine. Further, while the selected bacteria produce a primary enzyme that breaks down components of urine, they can also produce a secondary enzyme that kills bacteria commonly found in restrooms. This is a substantial departure from common urinal and restroom floor mats that are often treated with an antimicrobial compound to prevent the growth of such common bacteria, and thereby prevent the odor they produce. The microbial treatment can be done by dusting the floor mat with the bioactive material including selected bacterial. Alternatively, the bioactive material can be sprayed on the fluid capture layer in a wet application, and the mats that have been sprayed then dried and packaged for later use. In general, the bacteria is processed so as to be in spore form when applied to the urinal mat. The lack of a consumable material in the mat, when initially produced, results in the bacteria staying in spore form. However, when urine is present, the bacteria will transition to an active state and begin producing enzymes to break down urine, such as urease, producing ammonia and carbon dioxide as primary metabolites for the selected bacteria. Thus, by oxidizing ammonia, for example, odors associate with ammonia are reduced.

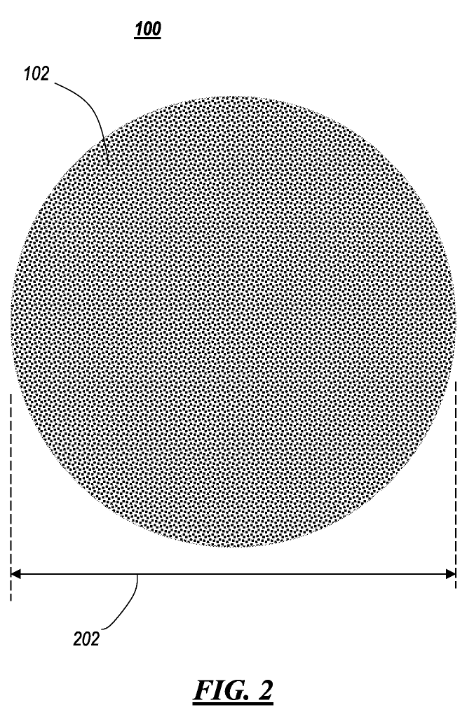

FIG. 2 is a top view of the floor mat of FIG. 1. In some embodiments, the floor mat 100 is a circular article having a diameter 202 of about sixteen inches or less. It has been found that in some applications the circular configuration corresponds roughly to fluid drop patterns under the urinal. Most of the fluid falls in a circular spot under the forward edge of the urinal. It also happens that the diameter of up to about sixteen inches (+/- 0.5”) isn’t so large as to cause most urinal users to have to stand with their feet uncomfortably spaced apart to avoid stepping/standing on the floor mat 100. In some embodiments, depending on the urinal design and height, it has been found that a circular floor mat 100 having a diameter of about ten to twelve inches is adequate to capture most of the errant fluid drops/droplets when the floor mat 100 is correctly positioned under the urinal. In other applications, however, a diameter of up to about sixteen inches is necessary.

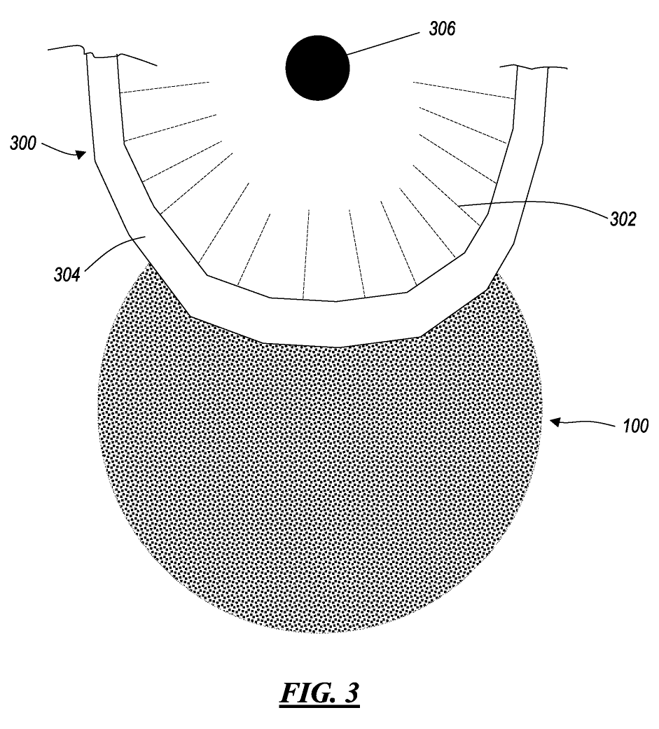

FIG. 3 is a top view of the floor mat 100 positioned under a urinal 300, in accordance with some embodiments. In this view the forward portion of the urinal 300 is shown, including a basin 302 and rim 304. Fluid entering the basin will flow to the drain opening 306, for the most part. Optimally, a urinal screen would be placed in the basin 302 to reduce, if not completely prevent, fluid splash out of the basin 302. In using a urinal, users tend to stand at a certain distance relative to the urinal; not so close that part of the user is within the urinal, but not so far away that urine will certainly drip onto the floor. Generally, users try to stand so that low velocity streaming or drops will fall at the front of the basin, however this can be misjudged by the user, resulting in some fluid falling to the floor mat 100 below. Without a floor mat being present, the floor could become wet, and in addition to producing undesirable odors, create a potential risk of a person slipping and falling.

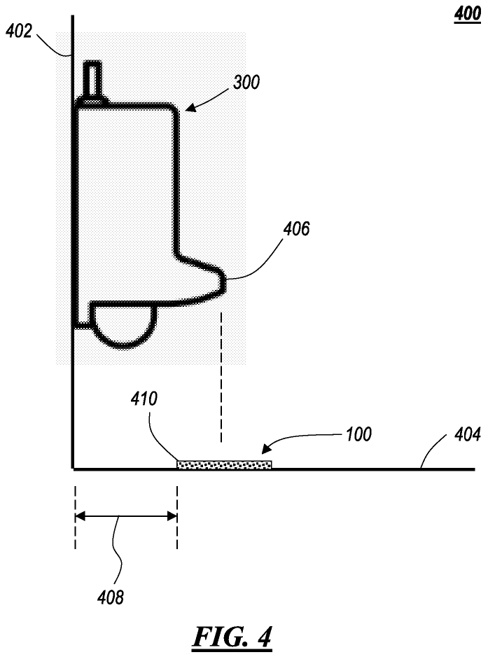

FIG. 4 is a side view 400 of a urinal 300 and floor mat 100 positioned under the urinal, in accordance with some embodiments. The urinal 300 is typically mounted on a wall 402 over a floor 404. The floor mat 100 is placed on the floor. In placing the floor mat 100, custodial personnel can remove the liner layer to expose the low-tack surface 110. If the floor 404 is clean and dry, then the low-tack surface, which can be a pressure sensitive adhesive, will tend to hold the floor mat in position, resting movement from inadvertent contact such as from user’s shoes. In general, the floor mat 100 can be disposed centrally under the front end 406 of the urinal 300. In some embodiments, the floor mat can be positioned so that the back edge 410 of the floor mat 100 is not farther from the wall 402 than the front end 406 of the urinal 300. In general, though, the easiest way to place the floor mat 100 is for personnel to look on the floor and see where there tends to be fluid on the floor under or in front of the urinal, and placing the urinal floor mat in that location (after cleaning the floor). It has been found that about 90% of errant splash and drip falls in a circular region under the urinal, and depending on the urinal height, the region can be eight to sixteen inches in diameter. In general, the circular body of the floor mat 100 has a diameter that is sized such that the circular body is spaced apart from the wall 402 (or other fixture, equivalently) on which the urinal 300, under which the minimized urinal floor mat 100 is placed, is mounted when the circular body is centered under a front end 406 of the urinal 300, and no other portion of the minimized urinal floor mat 100 is in contact with the wall 402. As a result, only the low tack bottom surface of the urinal floor mat 100 holds the urinal floor mat 100 in place under the front end 406 of the urinal 300.

Prior art urinal floor mats generally extend from the vertical wall 402 on which the urinal 300 is mounted, or some other fixture under the urinal, to a region in front of the urinal. That is, a conventional, prior art urinal mat is placed so that one edge of the mat is against the wall 402 (or other fixture), and it has a length so that a portion of the prior art mat will extend further from the wall than the front end 406 of the urinal under which is it mounted. By being against the wall 402 or other fixture, the mat is generally prevented from moving, at least in the direction of the wall, from being inadvertently kicked or otherwise jostled. While this will cover the floor, and catch urine that splashes out of the urinal or which drip onto the floor, most of the material of such a large floor mat is not utilized. However, the added weight of this largely unused material, in combination with being placed against the wall, results in the floor mat being resistant to moving around if/when users inadvertently kick or contact the mat when approaching or using the urinal.

Because the urinal floor mat of the present inventive disclosure doesn’t contact the wall, it cannot rely on the wall for positional retention. The low-tack surface alone is sufficient to resist inadvertent displacement by a user’s foot while still allowing easy removal and replacement. This combination of minimized sized and adhesive-only retention is structurally and functionally distinct from both ordinary bath mats (which are not sized or positioned for urinal splash patterns) and from prior-art urinal mats that must reach the wall to stay in place.

The inventive floor mat 100, conversely, covers an area in which the overwhelming majority of urine falls, and being minimized in size, the back edge 410, or point closest to the wall 402, is separated from the wall by a substantial distance 408. Where a prior art mat relies on bearing against the wall 402 to remain in place, and thereby using a substantial amount of material that is effectively unused for capturing urine or other fluid splash under the urinal 300. The minimized urinal mat 100 is sized to capture the vast majority of fluid splash under the urinal without needing the extra material to reach the wall 402 by virtue of the low tack bottom surface, which adheres to the floor 404 sufficiently to remain in place, once deployed. This eliminates the need for an excess amount of material that is needed by prior art mats to hold the prior art mat in place by bearing against the wall 402. Thus, the floor mats of the present disclosure can have a diameter in a range of eight to sixteen inches in some embodiments, depending on the height of the urinal, and more or less than that is some embodiments. In general, however, a diameter in the range of eight to sixteen inches has been found to capture a substantial majority of fluid splash under a urinal that would otherwise fall on the floor 404 without a mat being present. The eight-to-sixteen-inch diameter range is not arbitrary; it corresponds to the observed circular region under the front end of a typical wall-mounted urinal in which the great majority of splash and drip occurs. Larger sizes (characteristic of bath mats or conventional urinal mats) add material that contributes nothing to fluid capture under the urinal. For hexagonal urinal floor mats, the “diameter” refers to the distance from one vertex to the opposite vertex, e.g. the maximum straight line distance between opposing points.

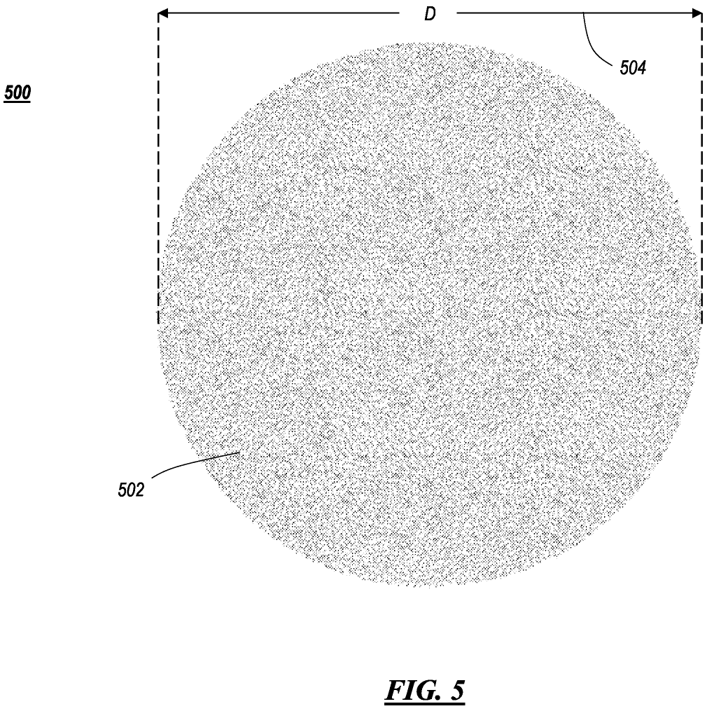

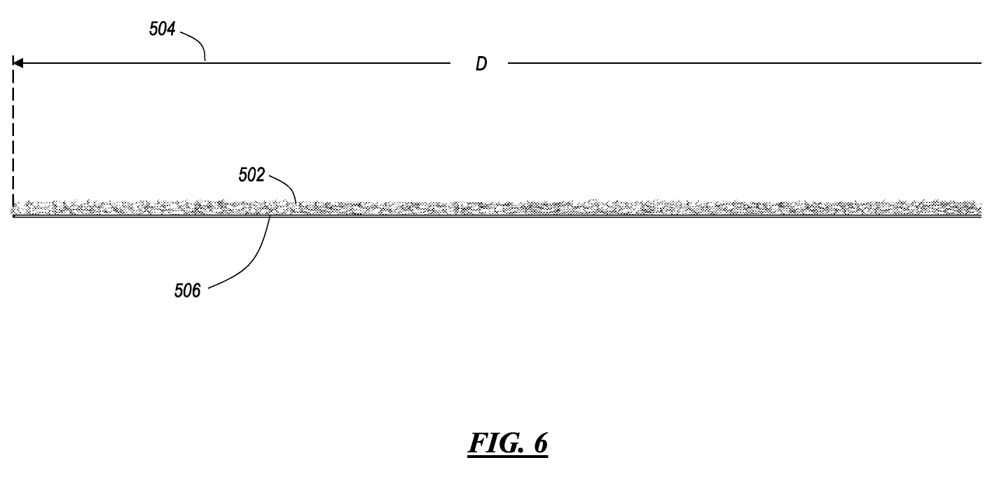

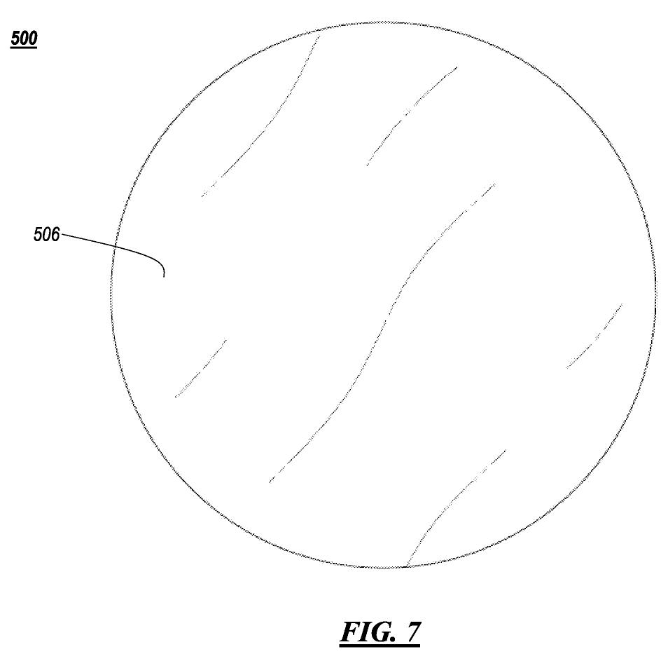

FIG. 5 is a top plan view of a urinal floor mat 500 having a fibrous fluid capture layer 502 that has a bioactive treatment, in accordance with some embodiments. In particular, the drawing shows the body of the floor mat 500 having a circular body. FIG. 6 shows a side view of the body of the floor mat 500, and FIG. 7 shows a bottom view of the body of the floor mat 500. The fibrous layer 502 can be created using, for example, a needle punch technique that is applied to staple fibers to create a non-woven web of interlocking fibers or fibrous material, such as a felt. After applying the needle punch process, a fibrous pile is created that can be compressed. In some embodiments the fibrous pile can be compressed down to about 3/16th of an inch, producing top side that, while having openings among the compressed fibers, is also flat, such that the fibers are not loose and at irregular heights. During the compression, heat can be applied to achieve the flat top. In some embodiments the body of the mat 500 can have a height or thickness of not more than one half of an inch and not less than 1/16 of an inch. The compressed pile is then section-cut to the desired size or diameter 504, and a backing layer 506 can be added before or after cutting. The backing layer can include a layer of pressure sensitive adhesive on the bottom that helps hold the urinal floor mat in place when placed on the floor under a urinal. The layer of fibrous material 502 captures and retains fluid using capillary action between the fiber. By “capture” is it meant that the fluid does not splash off of the fluid capture layer 502 to the surrounding surfaces, and is retained among the structure of the fluid capture layer 502, whether it is fibrous, made of protrusions, or some other fluid retaining structure. The backing layer 506 is a thin fluid barrier to prevent fluid passing through the mat 500 the floor under the mat. The bottom surface, which faces towards the floor, can have a tacky surface, such as by having pressure sensitive adhesive applied thereon. A liner can be placed over the bottom surface to prevent contamination prior to deployment under a urinal.

The fibrous layer 502 is treated with a bioactive material that breaks down components of urine. For example, a buffered bacterial broth of an appropriate dilution ratio can be sprayed on the fluid capture layer 502. The wetted mat can then be dried and packaged. The bacterial broth can include one or more species of Bacillus bacteria which are selected for their ability to break down components of urine while minimizing the production of compounds that produce or contribute to odor, such as ammonia. Bacillus subtilis, Bacillus licheniformis and Bacillus amyloliquefaciens, for example, are known to produce enzymes like amylase, urease, lipase, and protease, among others, which break down urea, lipids, carbohydrates, and proteins, which are found in urine, while minimizing the production of odor, compared to other types of bacteria commonly found in restrooms. Other genera of bacteria may be used alternatively, such as Amphibacillus spp., Lactobacillus spp., and Lactiplantibacillus spp. The enzymes produced by these bacteria break down urine by catalyzing the hydrolysis of peptide bonds in urea, proteins, lipids, and carbohydrates, and the products of such hydrolysis can be metabolized by the bacteria, or excreted. Thus, the bacteria used on the inventive urinal floor mats are selected, and different from those bacterial species commonly found in restrooms that are known to cause more odor, such as, for example, Escherichia coli, Enterococcus, and Klebsiella.

The bacteria are provided in spore form, where they are inactive. An amount on the order of 2 X 10⁴ to 2 X 10⁵ bacteria spores are provided on the mat. Once deployed, the presences of urine will result in the bacteria transitioning to an active form where they begin producing enzymes that break down the components of the urine and they consume some of those components. As an additional benefit, the selected bacteria can produce a secondary metabolite that has an anti-microbial effect on other species of bacteria, including E. coli and other bacteria commonly found in restrooms. This secondary metabolite is an evolutionary response to reduce competition for food, essentially.

As an example, a buffered bacterial broth sold under the trade name EVOBAC 40X by Genesis Biosciences, Inc., can be diluted in a proportion of 5 grams of broth to 32 ounces by volume of water. The diluted broth can then be sprayed onto the fluid capture layer of the mats at a predetermined rate and the mats then dried and packaged hermetically to protect the culture. Once the treated floor mat is deployed, and placed under a urinal, any droplets of urine will activate the bacteria, which will then commence breaking down components of the urine, including urea, lipids, proteins, and carbohydrates in urine. As a result, the urine will not produce the typical odor associated with urine build up in a public restroom. In fact, the bacterial culture can grow as more urine falls on the floor mat, making the floor mat more effective for a time. Thus, the disclosed urinal floor mat avoids the use of anti-microbial compositions and instead uses an active microbial culture to break down urine and prevent odor.

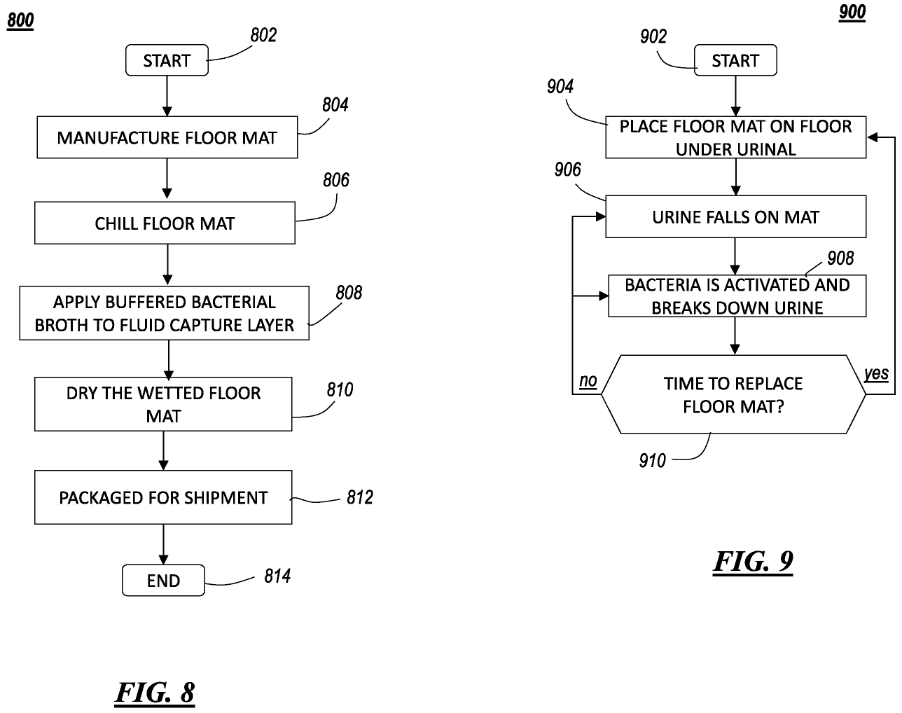

FIG. 8 is a flow chart diagram of a method 800 of making a bioactive treated urinal floor mat, in accordance with some embodiments. At the start 802 the various materials for the layers of the floor mat can be obtained. In step 804, a fluid capture material is made in a sheet or sheeting and joined onto a fluid barrier layer. A cutting process can be used to cut mats of a desired size and shape from the sheets of laminated material. Excess material can be recycled back into the raw materials to produce new fibrous sheets. A pressure sensitive adhesive and liner can be applied to the bottom of the fluid barrier layer. In step 806, because the lamination process can introduce heat into the mat, the mat or mat material can be chilled in order to bring it down to a temperature that will be harm the bacterial spores. In some embodiments the laminated fluid capture layer and moisture barrier layer must be below one hundred fifty degrees Fahrenheit in order to not harm the bacteria. In step 808 a bioactive treatment is applied to the fluid capture layer, such as by spraying a buffered bacterial broth mixture onto the fluid capture layer. The bacteria in the broth are in a dormant state (e.g. spore) but will become active in the presence of urine. Thereafter, in step 810, the wetted mats are dried at temperatures low enough to not harm the bacterial culture. Then the treated, dried mats are packaged in step 812 for shipment, and the method ends 814.

FIG. 9 is a flow chart diagram of a method 900 of using a bioactive treated urinal floor mat, in accordance with some embodiments. At the start 902, for example, a janitorial custodian can receive one or more packaged floor mats. In step 904, the floor mat is unpackaged and placed on the floor below a urinal. The floor mat is placed at a location in which the most urine falls, which is typically under the front end of the urinal basin, and slightly forward of where a urinal user would normally stand, on average. In step 906, while the floor mat is in use, urine occasionally falls on the mat, and in step 908 the fluid activates the bacteria, which breaks down components of the urine, thereby preventing the urine components from producing odors associated with urine. Step 910 is a check on whether the floor mat needs to be replaced. This can occur at a certain time period or if the floor mat begins losing effectiveness. For example, if the pH of the floor mat falls out of a range suitable for the Bacillus species, the culture on the mat may die off or otherwise become ineffective, and so a new floor mat would be required. If a new mat is needed, then the method 900 returns to step 904, otherwise steps 906 and 908 continue with the same floor mat.

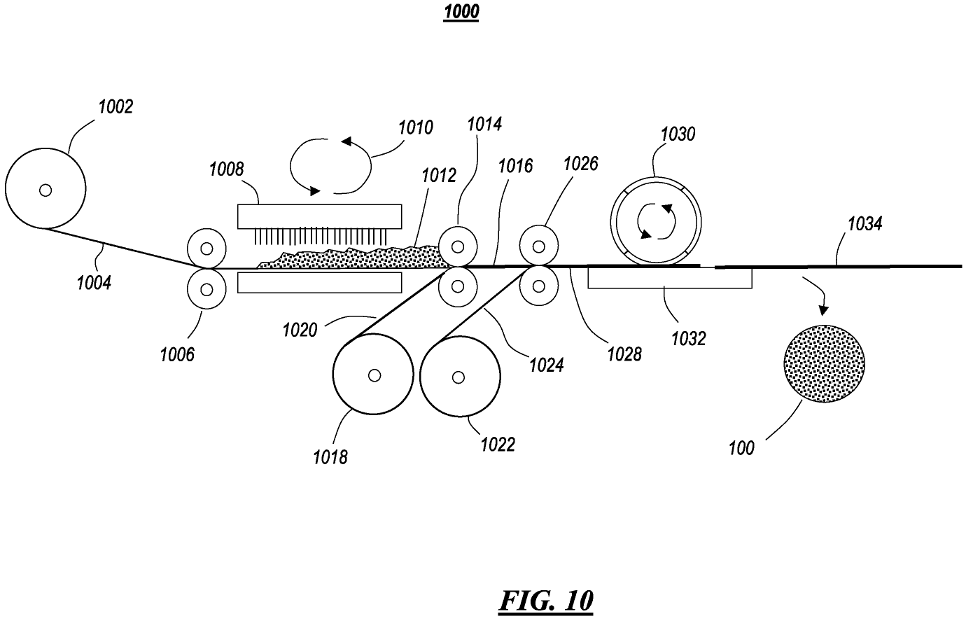

FIG. 10 shows a manufacturing system schematic 1000 of a manufacturing system for manufacturing minimized urinal floor mats, in accordance with some embodiments. A spool 1002 comprises a roll of a first sheet of material 1004. The material 1004 can be polymeric but is used to form the fluid capture layer of the minimized urinal floor mats. The material 1004 is guided by rollers 1006 into a needle punch operation in which a needle punch 1008 moves in a circular manner, as indicated by arrow 1010, to repeatedly drive a plurality of barbed needles through the material 1004, and withdraw the needles out of the material 1004, creating fibers 1012. The needle-punched material and fibers than pass through a compressing roller 1014 to compress the fibers 1012 into a pile that is about 3/16 of an inch high but can be between 1/16 of an inch to half an inch in height. The compressing roller 1014 can be heated to further facilitate producing a flat-top side of the compressed fiber layer. At the same time, second material 1020 is fed from a spool 1018 to form the moisture barrier layer. An adhesive may be applied to the second material 1020 to adhere to fluid capture layer formed from material 1004 in the compressing roller 1014. Thus at 1016 there is a fluid capture layer and a moisture barrier layer laminated together. A third spool 1022 can provide a backing material 1024 that is added to the lamination by rollers 1026. Thus, the laminate stock 1028 includes a fluid capture layer, moisture barrier layer, and backing layer. The laminate stock 1028 can be cut by a roller die 1030 against a backstop 1032. The roller die 1030 has a series or cutting surfaces around its outside surface that cut circular section of the laminate stock 1028 to produce singulated minimized urinal floor mats 100. The remaining laminate 1034 can be recycled. Alternative to the process exemplified by schematic 1000, the three materials 1004, 1020, and 1024 can be individually cut into same-size portions and then laminated together. In embodiments including the bacterial culture, the bacterial culture can be added to laminate 1028 or to individual mats 100, in accordance with the methods 800, 900. Although shown here as being circular, the singulated urinal floor mats can be cut in hexagons to maximize the yield from the laminate stock 1028.

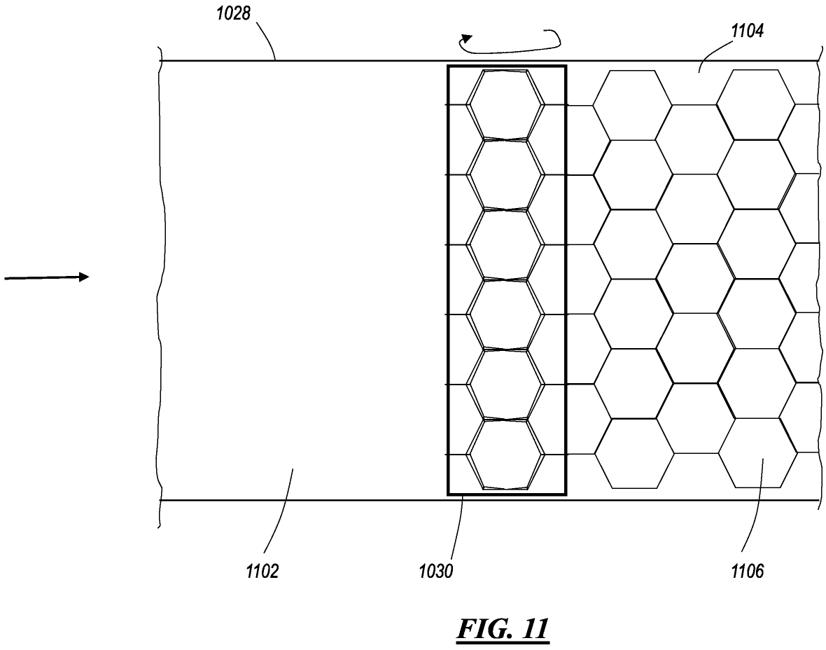

FIG. 11 show an overhead view of the cutting of laminate sheet 1028 into individual urinal floor mats 1106, in accordance with some embodiments. The laminate 1028 before it meets the die 1030 has an uncut side 1102, and a cut side 1104 and is moved in the direction of arrow 1100 to be cut by the die to produce the cut side 1104. In this example the die 1030 cuts hexagonal-shaped urinal floor mats 1106. The die 1030 include hexagonally configured blade walls that extend outward from a cylindrical body of the die 1030 so that as the die 1030 rotates it is continuously cutting the laminate stock 1028. Alternatively, and row of hexagonal dies can be lowered into contact with the laminate stock, which have a flat lower edge, and which are briefly moved with the movement of the laminate stock 1028 while being pressed into the laminate stock 1028 to cut the laminate stock 1028 into individual urinal floor mats 1106. The hexagonal shape maximizes the yield (number of urinal floor mats per unit area) from the laminate stock 1028 by reducing the unusable amount of scrap from laminate stock 1028. The individual urinal floor mats 1106 can fall into a collection bin while the edges of the laminate stock 1028 can be gathered for scrap or recycling.

A minimized urinal floor mat has been disclosed that both captures fluid under a urinal, and which can also include a bioactive treatment that provides bacteria which produce enzymes that break down components of urine and allow the bacteria to consume the products of the enzymatic action on urine components to produce less odor than would normally be produced by other forms of bacteria commonly found in restrooms were the urine to, for example, fall on the floor. It has been found that the floor mat need cover only a relatively small circular area under the front end of the urinal to capture most of the errant fluid falling to the floor, which is either splashed out of the urinal or which falls directly from the urinal user to the floor.

The claims appended hereto are meant to cover all modifications and changes within the scope and spirit of the present invention.

What is claimed is:

1. A floor mat for use under a urinal, comprising:
a fluid capture layer;
a moisture barrier layer on which the fluid capture layer is disposed;
a backing on a bottom of the moisture barrier layer that has a low-tack back surface; and
wherein at least one of the fluid capture layer or the moisture barrier layer is treated with a selected bacterial culture including bacteria in a dormant state, and wherein a presence of urine on the floor mat causes the bacteria to transition to an active state.

2. The floor mat of claim 1, wherein the fluid capture layer is a compressed pile of fibers having a flat top.

3. The floor mat of claim 1, wherein the floor mat is circular and has a diameter of not more than about sixteen inches.

4. The floor mat of claim 1 wherein the at least one of the fluid capture layer or the moisture barrier layer is made of a polymeric material.

5. The floor mat of claim 1, wherein the at least one of the fluid capture layer or the moisture barrier layer is made of ethylene vinyl acetate.

6. The floor mat of claim 1, further comprising a removable liner layer disposed on the backing.

7. The floor mat of claim 1, wherein the bacterial culture contains at least one species of Bacillus.

8. The floor mat of claim 7, wherein the bacterial culture contains a plurality of species of Bacillus.

9. The floor mat of claim 1, wherein the bacterial culture is applied as a diluted broth to the at least one of the fluid capture layer or the moisture barrier layer.

10. The floor mat of claim 1, wherein the bacteria of the selected bacterial culture produces a secondary metabolite that is anti-microbial to another species of bacteria.

11. A minimized urinal floor mat, comprising:
a circular body having a diameter sized such that the circular body is spaced apart from a wall on which a urinal, under which the minimized urinal floor mat is placed, is mounted when the circular body is centered under a front end of the urinal, and no other portion of the minimized urinal floor mat is in contact with the wall, the circular body including:
a fluid capture layer made of a fibrous material,
a moisture barrier layer across a bottom of the fluid capture layer; and
a backing on a bottom of the moisture barrier layer that has a low-tack surface forming a bottom of the circular body.

12. The urinal floor mat of claim 11, wherein the body is circular and has a diameter of eight to sixteen inches and a height of not more than of an inch.

13. The urinal floor mat of claim 11, wherein fluid capture layer is a non-woven felt.

14. The urinal floor mat of claim 13, wherein the felt is made of a polymeric material.

15. The urinal floor mat of claim 14, wherein the polymeric material is ethylene vinyl acetate.

16. The urinal floor mat of claim 11, wherein the low-tack surface comprises a pressure sensitive adhesive.

17. The urinal floor mat of claim 11, wherein the fluid capture layer comprises a buffered bacterial culture that contains at least one species of Bacillus.

18. The urinal floor mat of claim 17, wherein the buffered bacterial culture contains a plurality of species of Bacillus.

19. The urinal floor mat of claim 17, wherein the buffered bacterial culture is applied to the fluid capture layer as a diluted broth.

20. The urinal floor mat of claim 11, wherein the moisture barrier layer comprises rubber.

21. A method of making a floor mat for a urinal, comprising:
laminating a fluid capture layer of material to a moisture barrier layer of material, wherein the fluid capture layer comprises a compressed fibrous material having a flat top surface; and
applying a bacterial culture to the fluid capture layer, wherein the bacterial culture includes a selected bacteria species in a dormant state that transitions to an active state in the presence of urine.

22. The method of claim 21, further comprising chilling the laminated fluid capture layer and moisture barrier layer prior to applying the bacterial culture.

23. The method of claim 22 where the chilling results in the laminated fluid capture layer and moisture barrier layer being not more than one hundred fifty degrees Fahrenheit.

24. The method of claim 21, further comprising cutting the laminated fluid capture layer and moisture barrier layer.

25. The method of claim 24, wherein cutting the laminated fluid capture layer and moisture barrier layer comprises cutting the laminated fluid capture layer and moisture barrier layer into individual circular floor mats.

26. The method of claim 25, wherein cutting the laminated fluid capture layer and moisture barrier layer into individual circular floor mats comprises cutting the laminated fluid capture layer and moisture barrier layer into individual circular floor mats having a diameter of eight to sixteen inches.
